(19) United States
(12) Patent Application Publication
(10) Pub. No.: US 2021/0207529 A1
(43) Pub. Date: Jul. 8, 2021

(54) GASIFIER WALL, INTEGRATED GASIFICATION COMBINED CYCLE POWER GENERATION EQUIPMENT COMPRISING SAME, AND METHOD FOR PRODUCING GASIFIER WALL

(71) Applicant: MITSUBISHI HITACHI POWER SYSTEMS, LTD., Yokohama-shi, Kanagawa (JP)

(72) Inventors: Kenta Haari, Kanagawa (JP); Yasunari Shibata, Kanagawa (JP); Masashi Kitada, Kanagawa (JP); Fumihiro Chuman, Kanagawa (JP); Kenichiro Minato, Kanagawa (JP); Koichi Koga, Kanagawa (JP); Masakazu Matsui, Tokyo (JP); Yuzo Imagawa, Tokyo (JP)

(73) Assignee: MITSUBISHI HITACHI POWER SYSTEMS, LTD., Yokohama-shi, Kanagawa (JP)

(21) Appl. No.: 15/998,953

(22) PCT Filed: Feb. 8, 2017
(86) PCT No.: PCT/JP2017/004641

§ 371 Date: Aug. 17, 2018

(51) Int. Cl. F02C 3/28; F23M 5/08; F01K 23/06; F02C 6/18

(52) U.S. Cl. CPC F02C 3/28; F02C 6/18; F01K 23/067; F23M 5/08

(57) ABSTRACT

A gasifier wall is formed of a plurality of pipes through which a cooling medium flows. The plurality of pipes are made of a first material and arranged side by side. At least a part of the gasifier wall includes an outer peripheral portion stacked on a periphery of each of the pipes and made of a second material having higher corrosion resistance than the pipes; a board disposed between the outer peripheral portion and an adjacent outer peripheral portion; and a welded portion coupling the outer peripheral portion and the board. The outer peripheral portion and the board constitute a wall surface that separates an internal space and an external space from each other. The outer peripheral portion covers an entire region of the pipe in a circumferential direction.

### FIELD

The present invention relates to a gasifier wall on which cooling pipes are disposed in a gasification unit configured to gasify a carbonaceous feedstock such as coal by partial combustion, an integrated gasification combined cycle having the gasifier wall, and a method of manufacturing a gasifier wall.

### BACKGROUND

Conventionally, as a gasification unit, a carbonaceous fuel gasification unit (coal gasification unit) configured to supply a carbonaceous feedstock such as coal into a gasifier and incompletely combust the carbonaceous feedstock to produce combustible gas has been known. In the coal gasification unit, high-temperature gas passes inside a gasifier (furnace) wall inside of which combustion gas passes. Thus, a pipe channel through which a cooling medium passes is disposed inside the gasifier wall in order to suppress heating of the furnace wall.

Patent Literature 1 describes the structure of a furnace wall of a boiler, which is directed to a heat power plant and a refuse incinerator, and a method of manufacturing the furnace wall. Specifically, Patent Literature 2 describes a water-cooled wall panel including a plurality of cylindrical pipe channels through which cooling water pass and a coupling plate which is located between the pipe channels and whose both ends are bonded to the peripheral walls of the pipe channels. Furthermore, Patent Literature 2 describes a double pipe, specifically a heat transfer pipe for a heat exchanger, in which the inner pipe is made of carbon steel, stainless steel, or low alloy steel and the outer pipe is made of high alloy steel. Furthermore, Patent Literature 2 indicates that the outer pipe is manufactured by welding on the inner pipe.

### CITATION LIST

### Patent Literature

Patent Literature 1: Japanese Patent Application Laid-open No. 2013-154359

Patent Literature 2: Japanese Patent Application Laid-open No. 2001-263604

### SUMMARY

### Technical Problem

In a gasifier wall of a gasification unit, a space inside the gasifier is a corrosive atmosphere where high-temperature gas (combustible gas) of higher than 1,500° C. passes and an atmosphere with high thermal load, and the outside of the gasifier is a non-corrosive atmosphere where inert gas having temperature lower than that of the combustible gas flows. As measures for corrosion resistance of the gasifier wall inside the gasifier, a double pipe in which an outer pipe of an inner water-cooled pipe is made of corrosion-resistant alloy steel is conceivable, but when the adhesion and falling-off of slag such as coal on the gasifier wall surface are repeated, a temperature change occurs in the gasifier wall surface, and a temperature difference is apt to be large due to high temperature of higher than 1,500° C., resulting in that thermal stress may repeatedly occur between the inner pipe and the outer pipe due to the temperature distribution and the difference in material. Furthermore, in the case where the atmosphere temperature is greatly different between two spaces separated by the gasifier wall, if the difference in coefficient of linear expansion of corrosion-resistant materials of the inner pipe and the outer pipe on the gasifier wall surface increases, the thermal stress load may be more unevenly generated in the gasifier wall to be large load. To alleviate stress against thermal load, if the structure of the gasifier wall is complicated such that materials are layered for use such that the coefficient of thermal expansion sequentially changes from the inner pipe to the outer pipe, the weight of the furnace wall itself may increase and the manufacturing cost may rise. It is thus required to optimize the structure of the gasifier wall by comprehensively determining the required functions and problems.

It is therefore an object of the present invention to provide a gasifier wall having high durability even under environments where the atmosphere or temperature is different between the inside and outside of a wall portion and having a simple structure, an integrated gasification combined cycle having the gasifier wall, and a method of manufacturing a gasifier wall.

### Solution to Problem

To solve the problem described above, a gasifier wall is formed of a plurality of pipes through which a cooling medium flows, the plurality of pipes being made of a first material and being arranged side by side. At least a part of the gasifier wall includes an outer peripheral portion stacked on a periphery of each of the pipes and made of a second material having higher corrosion resistance than the pipes; a board disposed between the outer peripheral portion and an adjacent outer peripheral portion; and a welded portion coupling the outer peripheral portion and the board. The outer peripheral portion and the board constitute a wall surface that separates an internal space and an external space from each other. The outer peripheral portion covers an entire region of the pipe in a circumferential direction.

Consequently, the occurrence of corrosion inside the gasifier can be suppressed, and even under environments where the atmosphere or temperature is different between the inside and outside of the wall portion, the unevenness in stress and load can be reduced because the inside and the outside of the wall portion have the same configuration. The strength of the gasifier wall surface can be secured against the thermal load from the gasifier internal space side, and hence the durability can be enhanced.

Furthermore, the structure can be obtained by combining the pipe, the outer peripheral portion, the board, and the welded portion, and hence can be simplified.

The board is preferably made of a third material having higher corrosion resistance than the pipes. Forming the board from the third material that is higher in corrosion resistance than the pipe similarly to the second material facilitates welding bonding of the board and the outer peripheral portion.

Gas of 1,500° C. or higher preferably passes through the internal space. Even against high thermal load from the gasifier internal space side of higher than 1,500° C., the strength of the gasifier wall surface can be secured to increase the durability.

It is preferable Chat the internal space is a corrosive atmosphere, and the external space is a non-corrosive atmosphere. In this manner, even when the internal space is a corrosive atmosphere, the strength of the gasifier wall surface can be secured to obtain durability against the corrosive atmosphere.

Gas having a temperature higher than a temperature of gas in the external space preferably flows in the internal space. In this manner, even when the internal space is a high-temperature atmosphere, the strength of the gasifier wall surface can be secured to obtain durability against the corrosive atmosphere.

It is preferable that a ratio of a coefficient of thermal conductivity of the second material to a coefficient of thermal conductivity of the first material is 0.45 or more and 0.7 or less, and a ratio of a coefficient of thermal expansion of the second material to a coefficient of thermal expansion of the first material is 0.9 or more and 1.1 or less. Setting the coefficients of thermal conductivity of the first material and the second material to the above-mentioned range can further reduce the difference in elongation caused by the influence of heat. Consequently, thermal deformation of the gasifier can be suppressed. Furthermore, cooling performance of the water-cooled wall pipe can be enhanced. Furthermore, in the gasifier wall, by setting the coefficients of thermal expansion of the first material and the second material to the above-mentioned range, the difference in elongation caused by the influence of heat can be reduced. Consequently, the thermal stress in the gasifier can be suppressed.

The outer peripheral portion preferably has a thickness of larger than 0 and 5 mm or smaller. Setting the thickness of the outer peripheral portion to be larger than 0 can more reliably protect the pipe from corrosion. By setting the thickness of the outer peripheral portion to be 5 mm or smaller, thermal conductive characteristics necessary for the outer peripheral portion and the board can be maintained, and the temperature rise in the outer peripheral portion can be suppressed to improve the durability of the outer peripheral portion. Furthermore, heat of the pipe can be transferred to the outer peripheral portion and the board, and the cooling performance of the gasifier wall can be prevented from being lowered.

To solve the problem described above, an integrated gasification combined cycle includes a gasification unit having any one of the gasifier walls described above, the gasification unit being configured to gasify a carbonaceous feedstock to produce combustible gas; a gas turbine to be rotationally driven by combusting at least a part of the combustible gas produced by the gasification unit; a steam turbine to be rotationally driven by steam produced by a heat recovery steam generator to which turbine flue gas discharged from the gas turbine is introduced; and a generator coupled to the gas turbine and the steam turbine.

Consequently, gas produced by the highly reliable gasification unit can be supplied to the gas turbine, and the gas turbine and the steam turbine can be rotated to generate power by the generator.

To solve the problem described above, a method of manufacturing a gasifier wall includes the steps of: forming, on an entire outer circumference of each of a plurality of pipes made of first material, an outer peripheral portion made of a second material having higher corrosion resistance than the first material by overlay welding; disposing a board between the pipe on which the outer peripheral portion is formed and another pipe on which the outer peripheral portion is formed; and welding the board and the outer peripheral portion to each other to form a welded portion that fixes the board and the outer peripheral portion to each other.

Consequently, the furnace wall capable of suppressing the occurrence of corrosion and suppressing the increase in thermal stress in the board even under environments where the atmosphere or temperature is different between the inside and outside of a wall portion can be manufactured.

The step of forming the outer peripheral portion preferably includes spiral overlay welding in which overlay welding is performed while rotating the pipe to form the outer peripheral portion on the entire outer circumference of the pipe. Consequently, the outer peripheral portion can be simply formed while reducing the amount of heat input to the pipe. In this manner, the load on the pipe can be reduced to enhance the durability of the furnace wall.

### Advantageous Effects of Invention

According to the present invention, a gasifier wall having high durability even under environments where the atmosphere of temperature is different between the inside and outside of a wall portion and having a simple structure can be provided.

### BRIEF DESCRIPTION OF DRAWINGS

FIG. 1 is a schematic configuration diagram of an integrated coal gasification combined cycle to which a gasification unit according to the present embodiment is applied.

FIG. 2 is a schematic configuration diagram illustrating the gasification unit according to the present embodiment.

FIG. 3 is a cross-sectional view illustrating a schematic configuration of a gasifier wall of the gasification unit.

FIG. 4 is a partial perspective view illustrating the schematic configuration of the gasifier wall.

FIG. 5 is an enlarged cross-sectional view illustrating the schematic configuration of the gasifier wall.

FIG. 6 is a schematic diagram illustrating the relation between the gasifier wall and a burner.

FIG. 7 is an enlarged cross-sectional view illustrating a schematic configuration of a gasifier wall to be compared.

FIG. 8 is a flowchart illustrating an example of a method of manufacturing a gasifier wall.

### DESCRIPTION OF EMBODIMENTS

Embodiments of the present invention are described in detail below with reference to the drawings. Note that the present invention is not limited by the embodiments. Components in the following embodiments include components that can easily be replaced by a person skilled in the art or substantially the same components. The components described below can be combined as appropriates and when there are embodiments, the embodiments can be combined as well.

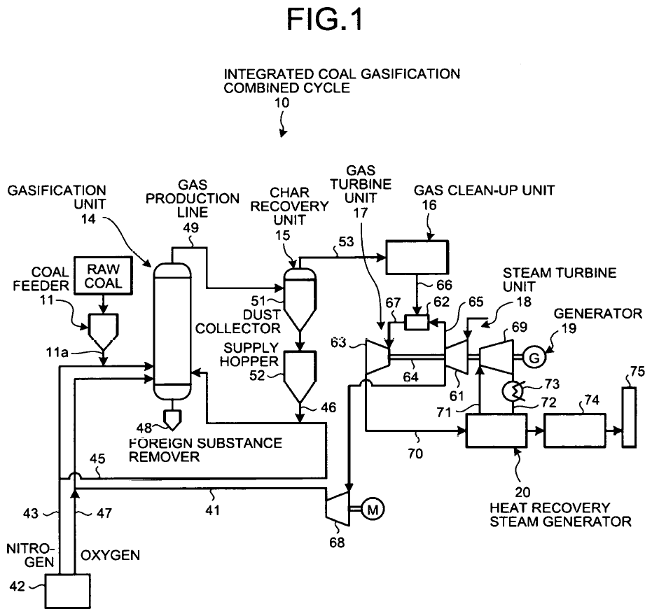

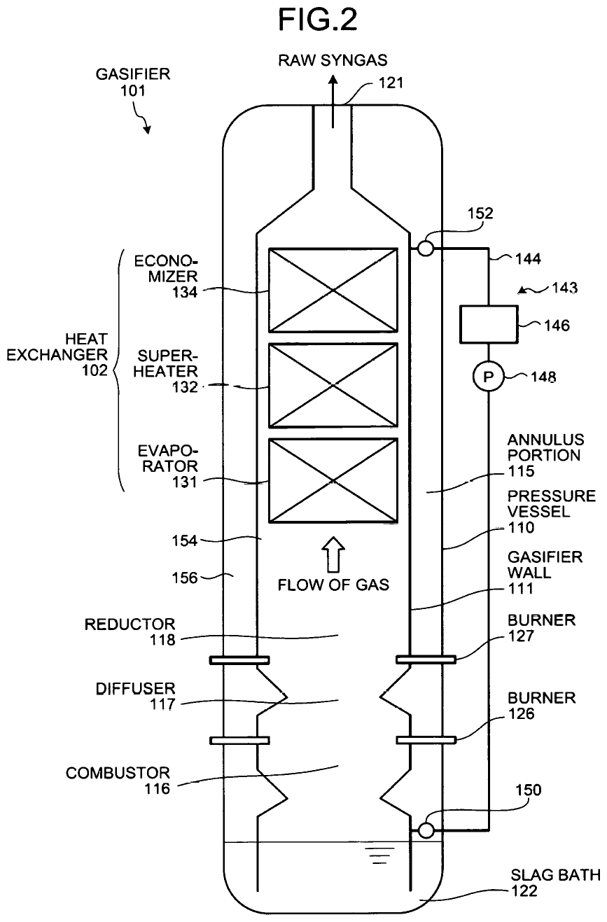

FIG. 1 is a schematic configuration diagram of an integrated coal gasification combined cycle to which a gasification unit according to the present embodiment is applied. FIG. 2 is a schematic configuration diagram illustrating the gasification unit according to the present embodiment.

An integrated coal gasification combined cycle (IGCC) 10 to which a gasification unit 14 according to the present embodiment is applied uses airs as oxygen containing gas, and employs an air combustion system in which the gasification unit 14 produces raw syngas from a fuel. Then, in the integrated coal gasification combined cycle 10, the raw syngas produced by the gasification unit 14 is refined by a gas clean-up unit 16 to obtain fuel gas, and the fuel gas is then supplied to a gas turbine unit 17 to generate power. Specifically, the integrated coal gasification combined cycle 10 according to the present embodiment is equipment using an air combustion system (air blowing). As a fuel supplied to the gasification unit 14, for example, a carbonaceous feedstock such as coal is used.

As illustrated in FIG. 1, the integrated coal gasification combined cycle (integrated gasification combined cycle) 10 includes a coal feeder 11, the gasification unit 14, a char recovery unit 15, the gas clean-up unit 16, the gas turbine unit 17, a steam turbine unit 18, a generator 19, and a heat recovery steam generator (HRSG) 20.

The coal feeder 11 is supplied with coal, which is a carbonaceous feedstock, as raw coal, and pulverizes the coal with a coal mill (not illustrated) to manufacture pulverized coal in fine particles. The pulverized coal manufactured by the coal feeder 11 is fed toward the gasification unit 14 by nitrogen serving as carrier inert gas supplied from an air separation unit 42 described later.

The gasification unit 14 is supplied with the pulverized coal manufactured by the coal feeder 11, and char (unreacted component and ash component of coal) recovered by the char recovery unit 15 is returned and supplied to the gasification unit 14 such that the char is reusable. The inert gas has an oxygen content of about 5% by volume or less. Representative examples of the inert gas include nitrogen gas, carbon dioxide gas, and argon gas, but the oxygen content is not necessarily required to be limited to about 5% or less.

Furthermore, a compressed air supply line 41 from the gas turbine unit 17 (compressor 61) is connected to the gasification unit 14, and air compressed by the gas turbine unit 17 can be supplied to the gasification unit 14. The air separation unit 42 separates and produces nitrogen and oxygen from air in the atmosphere, and the air separation unit 42 and the gasification unit 14 are connected to each other through a first nitrogen supply line 43. Then, a coal feed line 11a from the coal feeder 11 is connected to the first nitrogen supply line 43. Furthermore, a second nitrogen supply line 45 branching from the first nitrogen supply line 43 is also connected to the gasification unit 14, and a char return line 46 from the char recovery unit 15 is connected to the second nitrogen supply line 45. In addition, the air separation unit 42 is connected to the compressed air supply line 41 through an oxygen supply line 47. Nitrogen separated by the air separation unit 42 flows through the first nitrogen supply line 43 and the second nitrogen supply line 45 to be used as gas for conveying coal and char. Furthermore, oxygen separated by the air separation unit 42 flow through the oxygen supply line 47 and the compressed air supply line 41 to be used as an oxygen containing gas in the gasification unit 14.

For example, the gasification unit 14 has a two-stage entrained-bed gasifier. The gasification unit 14 partially combusts coal (pulverized coal) supplied to the inside thereof with an oxygen containing gas (air, oxygen) to produce combustible gas. Note that, in the gasification unit 14, a foreign substance remover 48 configured Lo remove foreign substances mixed in pulverized coal is provided. Then, a gas production line 49 for supplying combustible gas toward the char recovery unit 15 is connected to the gasification unit 14, and combustible gas containing char can be discharged. In this case, a gas cooler may be provided to the gas production line 49 such that combustible gas is supplied to the char recovery unit 15 after being cooled to a predetermined temperature.

The char recovery unit 15 includes a dust collector 51 and a supply hopper 52. In this case, the dust collector 51 is configured by one or more porous filters or cyclones, and can separate char contained in combustible gas produced by the gasification unit 14. Then, combustible gas from which char has been separated is sent to the gas clean-up unit 16 through a gas discharge line 53. The supply hopper 52 stores therein char separated from the combustible gas by the dust collector 51. Note that a bin may be disposed between the dust collector 51 and the supply hopper 52, and a plurality of the supply hoppers 52 may be connected to the bin. Then, a char return line 46 from the supply hopper 52 is connected to the second nitrogen supply line 45.

The gas clean-up unit 16 purifies the combustible gas from which char has been separated by the char recovery unit 15 by removing impurities such as sulfur compounds and nitrogen compounds. Then, the gas clean-up unit 16 purifies the combustible gas to manufacture fuel gas, and supplies the fuel gas to the gas turbine unit 17. Note that the combustible gas from which char has been separated still contains sulfur contents (such as H₂S), and hence the gas clean-up unit 16 removes the sulfur contents with amine absorbing liquid, so that the sulfur contents are effectively used.

The gas turbine unit 17 has the compressor 61, a combustor 62, and a turbine 63. The compressor 61 and the turbine 63 are coupled to each other through a rotating shaft 64. A compressed air supply line 65 from the compressor 61, a fuel gas supply line 66 from the gas clean-up unit 16, and a combustion gas supply line 67 extending toward the turbine 63 are connected to the combustor 62. Furthermore, in the gas turbine unit 17, a compressed air supply line 41 extending from the compressor 61 to the gasification unit 14 is provided, and a booster 68 is provided at a middle part. Thus, in the combustor 62, compressed air supplied from the compressor 61 and fuel gas supplied from the gas clean-up unit 16 are mixed and combusted to produce combustion gas, and the produced combustion gas is supplied toward the turbine 63. Then, the turbine 63 rotationally drives the rotating shaft 64 with the supplied combustion gas, thereby rotationally driving the generator 19.

The steam turbine unit 18 has a turbine 69 coupled to the rotating shaft 64 in the gas turbine unit 17. The generator 19 is coupled to a base end portion of the rotating shaft 64. A flue gas line 70 from the gas turbine unit 17 (turbine 63) is connected to the heat recovery steam generator 20. The heat recovery steam generator 20 exchanges heat between water and flue gas to produce steam. Then, a steam supply line 71 is provided between the heat recovery steam generator 20 and the turbine 69 in the steam turbine unit 18. A steam recovery line 72 is also provided therebetween, and a condenser 73 is provided in the steam recovery line 72. Furthermore, steam produced by the heat recovery steam generator 20 may include the one obtained by further exchanging heat in the heat recovery steam generator 20 with steam produced by heat exchange with the raw syngas in the heat exchanger 102 in the gasifier 101. Thus, in the steam turbine unit 18, the turbine 69 is rotationally driven by steam supplied from the heat recovery steam generator 20, and the rotating shaft 64 is rotated to rotationally drive the generator 19.

Then, a gas purifier 74 is provided between an outlet of the heat recovery steam generator 20 and a stack 75.

Now, operations of the integrated coal gasification combined cycle 10 according to the present embodiment are described.

In the integrated coal gasification combined cycle 10 according to the present embodiment, when raw coal (coal) is supplied to the coal feeder 11, the coal is pulverized into fine particles by the coal feeder 11 to be pulverized coal. The pulverized coal manufactured by the coal feeder 11 flows through the first nitrogen supply line 43 by nitrogen supplied from the air separation unit 42, and is supplied to the gasification unit 14. Furthermore, char recovered by the char recovery unit 15 described later flows through the second nitrogen supply line 45 by nitrogen supplied from the air separation unit 42, and is supplied to the gasification unit 14. In addition, compressed air extracted from the gas turbine unit 17 described later is boosted by the booster 68, and then flows through the compressed air supply line 41 to be supplied to the gasification unit 14 together with oxygen supplied from the air separation unit 42.

In the gasification unit 14, the supplied pulverized coal and char are combusted by compressed air (oxygen), and the pulverized coal and char are gasified to produce combustible gas (raw syngas). Then, the combustible gas is discharged from the gasification unit 14 through the gas production line 49, and is sent to the char recovery unit 15.

In the char recovery unit 15, the combustible gas is first supplied to the dust collector 51, and fine char contained in the combustible gas is separated. Then, the combustible gas from which char has been separated is sent to the gas clean-up unit 16 through the gas discharge line 53. On the other hand, the fine char separated from the combustible gas deposits on the supply hopper 52, and is returned to the gasification unit 14 through the char return line 46 to be recycled.

The combustible gas from which char has been separated by the char recovery unit 15 is purified by the gas clean-up unit 16 by removing impurities such as sulfur compounds and nitrogen compounds, thereby manufacturing fuel gas. The compressor 61 produces compressed air and supplies the compressed air to the combustor 62. The combustor 62 mixes and combusts the compressed air supplied from the compressor 61 with the fuel gas supplied from the gas clean-up unit 16 to produce combustion gas. The turbine 63 can be rotationally driven with the combustion gas, and the generator 19 can be rotationally driven through the rotating shaft 64 to generate power. In this manner, the gas turbine unit 17 can generate power.

Then, the heat recovery steam generator 20 exchanges heat between the flue gas discharged from the turbine 63 in the gas turbine unit 17 and water to produce steam, and supplies the produced steam to the steam turbine unit 18. In the steam turbine unit 18, the turbine 69 can be driven with the steam supplied from the heat recovery steam generator 20, and the generator 19 can be rotationally driven through the rotating shaft 64 to generate power. Note that the gas turbine unit 17 and the steam turbine unit 18 are not necessarily required to rotationally drive the single generator 19 as the same shaft, and may rotationally drive a plurality of generators as different shafts.

After that, in the gas purifier 74, harmful substances in exhaust gas discharged from the heat recovery steam generator 20 are removed, and the purified flue gas is released to the atmosphere through the stack 75.

Next, the gasification unit 14 in the above-mentioned integrated coal gasification combined cycle 10 is described in detail with reference to FIG. 1 and FIG. 2.

As illustrated in FIG. 2, the gasification unit 14 includes a gasifier 101 and a heat exchanger 102.

The gasifier 101 is formed to extend in the vertical direction. Pulverized coal and oxygen are supplied to the lower side in the vertical direction, and combustible gas (raw syngas) obtained by gasifying the pulverized coal by partial combustion flows from the lower side to the upper side in the vertical direction. The gasifier 101 includes a pressure vessel 110, and a gasifier wall 111 provided inside the pressure vessel 110. Then, the gasifier 101 has an annulus portion 115 formed in a space between the pressure vessel 110 and the gasifier wall 111. Furthermore, in the gasifier 101, a combustor 116, a diffuser 117, and a reductor 118 are formed in the stated order in a space inside the gasifier wall 111 on the lower side in the vertical direction (that is, on the upstream side in the flowing direction of the raw syngas).

The pressure vessel 110 is formed into a cylindrical shape having a hollow space inside. A gas discharge outlet 121 is formed at an upper end portion of the pressure vessel 110, and a slag bath 122 is formed at a lower end portion (bottom portion) thereof. The gasifier wall 111 is formed into a cylindrical shape having a hollow space inside, and the wall surface thereof is provided to be opposed to the inner surface of the pressure vessel 110. In the present embodiment, the pressure vessel 110 is formed into a circular cylindrical shape, and the gasifier wall 111 is formed into a polygonal cylindrical shape or a circular cylindrical shape. Then, the gasifier wall 111 is coupled to the inner surface of the pressure vessel 110 through a support member (not illustrated).

The gasifier wall 111 is a cylindrical member configured to separate the inside of the pressure vessel 110 into an internal space 154 and an external space 156. The gasifier wall 111 is not a cylinder whose cross-sectional shape is unchanged, but unevenness and narrow parts are partially provided. An upper end portion of the gasifier wall 111 is connected to the gas discharge outlet 121 in the pressure vessel 110, and a lower end portion of the gasifier wall 111 is provided with a gap from a bottom portion of the pressure vessel 110. Then, water is stored in the slag bath 122 formed at the bottom portion of the pressure vessel 110. The lower end portion of the gasifier wall 111 is immersed in the stored water, thereby sealing the inside and outside of the gasifier wall 111. Burners 126 and 127 are inserted to the gasifier wall 111. The heat exchanger 102 is disposed in the internal space 154. The structure of the gasifier wall 111 is described later.

The annulus portion 115 is a space formed on the inner side of the pressure vessel 110 and on the outer side of the gasifier wall 111, that is, the external space 156. Nitrogen, which is inert gas separated by the air separation unit 42, is supplied through a nitrogen supply line (not illustrated). Thus, the annulus portion 115 is a space filled with nitrogen. Note that an in-furnace pressure uniforming pipe (not illustrated) configured to uniform the pressure in the gasifier 101 is provided in the vicinity of the upper part of the annulus portion 115 in the vertical direction. The in-furnace pressure uniforming pipe is provided to communicate the inside and outside of the gasifier wall 111, and makes uniform the pressure inside the gasifier wall 111 (combustor 116, diffuser 117, and reductor 118) and outside the gasifier wall 111 (annulus portion 115).

The combustor 116 is a space in which pulverized coal, char, and air are partially combusted. A combustion device configured by burners 126 is disposed on the gasifier wall 111 of the combustor 116. High-temperature combustion gas obtained by partially combusting pulverized coal and char in the combustor 116 passes through the diffuser 117 to flow into the reductor 118.

The reductor 118 is a space which is maintained Lu a high-temperature state necessary for gasification reaction and in which pulverized coal is supplied to combustion gas from the combustor 116 and the pulverized coal is pyrolyzed to be volatile components (such as carbon monoxide, hydrogen, and low hydrocarbon) to be gasified, thereby producing combustible gas. The combustion device formed of a plurality of burners 127 is disposed on the gasifier wall 111 of the reductor 118.

The heat exchanger 102 is provided inside the gasifier wall 111, and provided above the burner 127 in the reductor 118 in the vertical direction. In the heat exchanger 102, an evaporator 131, a superheater 132, and an economizer 134 are disposed in the stated order from the vertically lower side of the gasifier wall 111 (upstream side of raw syngas in flowing direction). The heat exchanger 102 exchanges heat with raw syngas produced in the reductor 118 to cool the raw syngas. Note that the numbers of evaporators 131, superheaters 132, and economizers 134 are not limited to the ones illustrated in the figures.

Now, operations of the gasification unit 14 according to the above-mentioned present embodiment are described. In the gasifier 101 in the gasification unit 14, nitrogen and pulverized coal are input and ignited by the burners 127 in the reductor 118, and pulverized coal, char, and compressed air (oxygen) are input and ignited by the burners 126 in the combustor 116. Then, in the combustor 116, high-temperature combustion gas is generated by combustion of pulverized coal and char. Furthermore, in the combustor 116, melted slag is produced in high-temperature gas due to combustion of the pulverized coal and the char, and the melted slag adheres to the gasifier wall 111 and falls to the bottom of the furnace, and is finally discharged to stored water in the slag bath 122. Then, the high-temperature combustion gas generated in the combustor 116 passes through the diffuser 117 to rise to the reductor 118. The reductor 118 is maintained to the high-temperature state necessary for gasification reaction. The pulverized coal is mixed with the high-temperature combustion gas, and the pulverized coal is pyrolyzed to be volatile components (such as carbon monoxide, hydrogen, and low hydrocarbon) in the high-temperature reducing atmosphere to perform gasification reaction, thereby producing combustible gas (produced gas). The gasified combustible gas (produced gas) flows from the lower side to the upper side in the vertical direction.

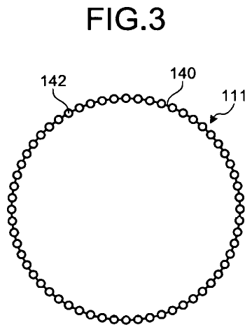

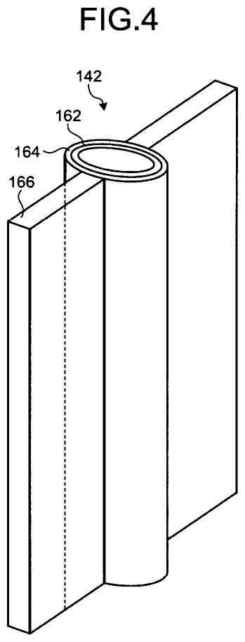

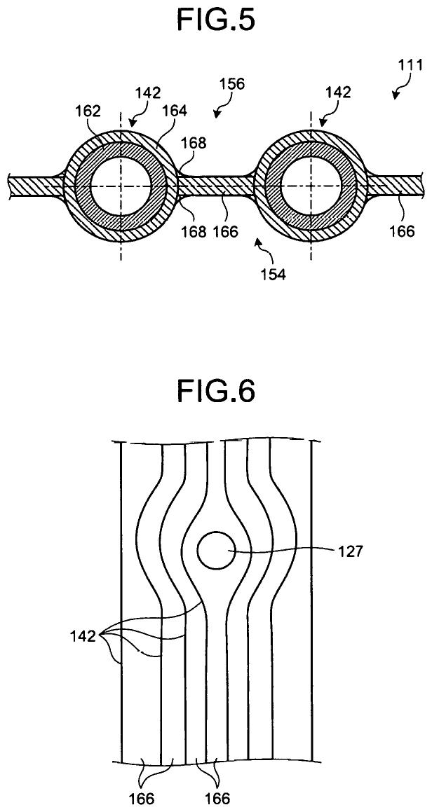

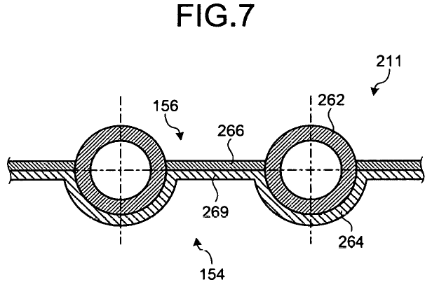

Next, the gasifier wall is described in detail with reference to FIG. 3 to FIG. 7 in addition to FIG. 2. FIG. 3 is a cross-sectional view illustrating a schematic configuration of the gasifier wall of the gasification unit. FIG. 4 is a partial perspective view illustrating the schematic configuration of the gasifier wall. FIG. 5 is an enlarged cross-sectional view illustrating the schematic configuration of the gasifier wall. FIG. 6 is a schematic diagram illustrating the relation between the gasifier wall and a burner. FIG. 7 is an enlarged cross-sectional view illustrating a schematic configuration of a gasifier wall to be compared.

The gasifier wall 111 has a polygonal cylindrical shape or a circular cylindrical shape, and has a circular cylindrical shape in the form illustrated in FIG. 3. A plurality of water-cooled wall pipes 142 are provided on a wall portion 140 having a cylindrical shape. Specifically, the water-cooled wall pipes 142 are provided on a part of the wall portion 140.

The gasification unit 14 has a cooling water circulation mechanism 143 configured to circulate refrigerant (such as water and steam as cooling water) in the water-cooled wall pipes 142. The cooling water circulation mechanism 143 has a circulation path 144, a pump 148, an inlet header 150, and an outlet header 152. The circulation path 144 is connected to both ends of the water-cooled wall pipes 142 through the inlet header 150 and the outlet header 152. Lower end portions of the water-cooled wall pipes 142 are gathered at the inlet header 150, and upper end portions thereof are gathered at the outlet header 152. The water-cooled wall pipes 142 are provided to extend along the vertical direction over the entire region of the gasifier 101. Without cutting a part of the water-cooled wall pipes or adding another heat transfer pipe, the same water-cooled wall pipes 142 extend from the top to bottom in the vertical direction and arranged in the circumferential direction to form the wall portion 140 of the gasifier 101. In the circulation path 144, a cooling device 146 and the pump 148 are provided.

In the circulation path 144, the cooling device 146 may be provided. The cooling device 146 exchanges heat to cool the cooling water that has passed through the water-cooled wall pipes 142 and increased in temperature. For example, the cooling device 146 may be a steam generator. A part of a water supply pipe (not illustrated) from the outside is supplied to the inlet header 150 through the pump 148, and the other part is supplied to the economizer 134. A steam drum (not illustrated) is coupled to the outlet header 152, and is coupled to a heat transfer pipe of the evaporator 131, a heat transfer pipe of the superheater 132, and a heat transfer pipe of the economizer 134 through pipes (not illustrated). Heat is exchanged with gas produced by the reductor 118 to generate steam from the water. The generated steam is coupled to the steam turbine unit 18 through a steam discharge pipe (not illustrated) together with the steam generated by the heat recovery steam generator 20. Furthermore, the produced gas is cooled by heat exchange, and is discharged from the gas discharge outlet 121 at the upper end portion of the pressure vessel 110.

The pump 148 sends the cooling water flowing through the circulation path 144 to a predetermined direction, and forms the flow of the cooling water in the circulation path 144 and the water-cooled wall pipes 142. The pump 148 forms the flow of the cooling water in the water-cooled wall pipes 142 from the lower side toward the upper side in the vertical direction. The inlet header 150 is disposed in the annulus portion 115, that is, the external space 156 between the gasifier wall 111 and the pressure vessel 110.

The inlet header 150 is connected to the vertically lower end portions of the water-cooled wall pipes 142. The inlet header 150 supplies the cooling water flowing through the circulation path 144 by the pump 148 to the water-cooled wall pipes 142 after equalizing the pressure of the cooling water. The outlet header 152 is connected to the vertically upper end portions of the water-cooled wall pipes 142. The outlet header 152 supplies the cooling water (hot water and steam) discharged from the water-cooled wall pipes 142 to the circulation path 144. In this manner, the cooling water circulation mechanism 143 supplies the cooling water to the water-cooled wall pipes 142.

Next, the structures of the wall portion 140 and the water-cooled wall pipe 142 in the gasifier wall 111 are described in more detail. At least a part of the water-cooled wall pipes 142 has a pipe 162 and an outer peripheral portion 164 provided on the outer periphery of the pipe 162. The pipe 162 is a pipeline through which cooling water flows. The outer peripheral portion 164 is disposed on the entire circumference of the pipe 162 in the circumferential direction, and covers the outer peripheral surface of the pipe 162. For example, the outer peripheral portion 164 is formed by overlay welding on the surface of the pipe 162.

The wall portion 140 has a board (fin) 166 provided between a water-cooled wall pipe 142 and a water-cooled wall pipe 142. The wall portion 140 in the present embodiment has a cylindrical shape formed by concentrically disposing the water-cooled wall pipes 142 and closing the region between a water-cooled wall pipe 142 and a water-cooled wall pipe 142 with the board 166. Furthermore, the wall portion 140 has a welded portion 168 coupling the outer peripheral portion 164 of the water-cooled wall pipe 142 and the board 166 to each other. The welded portions 168 are formed at an end portion of a contact part of the outer peripheral portion 164 and the board 166 on the internal space 154 side and at an end portion thereof on the external space 156 side. The welded portion 168 is formed by welding, and is in close contact with both the outer peripheral portion 164 and the board 166 to couple the outer peripheral portion 164 and the board 166 to each other.

Furthermore, the burners 126 and 127 are inserted to the gasifier wall 111 as described above. As illustrated in FIG. 6, in the gasifier wall 111 at the position where the burner 127 is inserted, the water-cooled wall pipes 142 near the position where the burner 127 is inserted have a shape warped along the burner 127. Furthermore, the boards 166 disposed between the warped water-cooled wall pipes 142 are partially broadened along the water-cooled wall pipes 142. In the board 166, a hole for inserting the burner 127 is formed at the position where the burner 127 is inserted in the broad region. Furthermore, in the circumferential direction of the gasifier wall 111, the boards 166 and the water-cooled wall pipes 142 around the board 166 to which the burner 127 is inserted are small in width (narrow) in the axial direction at the position where the burner 127 is inserted and are large in width (wide) at other parts. Consequently, the degree of warpage of the water-cooled wall pipes 142 becomes smaller as being away from the burner 127, and the water-cooled wall pipes 142 away from the burner 127 by a predetermined number of pipes can be made straight. Note that, in FIG. 6, the shape of the gasifier wall 111 at the position where the burner 127 is inserted is illustrated, but the gasifier wall 111 at the position where the burner 126 is inserted has the same shape.

In the gasifier wall 111, the pipe 162 is made of first material and the outer peripheral portion 164 is made of second material. Furthermore, the board 166 and the welded portion 168 may be made of the second material. The first material and the second material are metal. The second material is higher in corrosion resistance and higher in heat resistance than the first material. In the gasifier wall 111, the outer peripheral portion 164 is formed of material that is higher in corrosion resistance and higher in heat resistance than the material of the pipe 162, and hence the pipe 162 can be protected. Specifically, a fluid containing oxygen and fuel flows in the internal space 154 which is inside the gasifier wall 111 and in which combustible gas flows, and the temperature in the internal space 154 is high. The surface of the pipe 162 on the internal space 154 side is covered with the outer peripheral portion 164, and hence the pipe 162 can be protected from usage environments of corrosion and high temperature. Furthermore, if a temperature change has occurred in the wall surface of the gasifier wall 111 due to adhesion and falling-off of slag such as coal on the pipe 162, the outer peripheral portion 164, or the board 166 of the gasifier wall 111 and a temperature distribution has occurred in the pipes 162 or the outer peripheral portions 164, the influence of thermal expansion difference depending on the difference in material is increased to increase local thermal stress. In addition, the internal space 154 is a high-temperature atmosphere of higher than 1,500° C., where the temperature difference is apt to be large. Thus, in the present embodiment, a part of the gasifier wall 111 on the external space 156 side and a part of the gasifier wall 111 on the internal space 154 side have the same shape that is symmetrical about a plane connecting the axial center of the pipe 162 and the center of the board 166 in the thickness direction, so that even when a local temperature distribution occurs, the increase in thermal load caused by thermal expansion difference can be suppressed to improve the durability of the gasifier wall 111.

Furthermore, the outside of the gasifier wall 111 is the external space 156, which is a non-corrosive atmosphere filled with nitrogen. In the internal space 154, the temperature is different depending on the height position in the vertical direction, and the combustor 116 is a high-temperature atmosphere of higher than 1,500° C. and a corrosive atmosphere where combustion reaction is performed. The external space 156, on the other hand, is a space where the temperature is lower than that in the internal space 154, and is a non-corrosive atmosphere of about 100° C. Refrigerant flows through the pipe 162, and hence the temperatures of the outer peripheral portion 164 of the pipe 162 and the board 166 are several hundreds of degrees, and at the same position in the vertical direction, the temperature distribution is suppressed to be small due to the flow of the refrigerant. In the present embodiment, the surface of the pipe 162 on the external space 156 is also provided with the same outer peripheral portion 164 as that on the internal space 154 side, which enables the outer peripheral portion 164 to be disposed at a contact portion of the board 166 and the water-cooled wall pipe 142. The contact portion of the board 166 and the water-cooled wall pipe 142 is the welded portion 168. With this structure, the gasifier wall 111 through which high-temperature gas (combustible gas) of higher than 1,500° C. flows can have durability against a corrosive atmosphere and a temperature different atmosphere even under environments where thermal load is high and thermal stress due to temperature difference easily occurs.

For example, a gasifier wall 211 to be compared is illustrated in FIG. 7. The gasifier wall 211 to be compared has a board 266 provided between a pipe 262 and a pipe 262. The pipe 262 and the board 266 are coupled to each other by welding or the like. Furthermore, an outer peripheral portion 264 and a protection wall 269 are provided on the surfaces of the pipe 262 and the board 266 on the internal space 154 side. The pipe 262 and the board 266 are made of first material. The outer peripheral portion 264 and the protection wall 269 are made of second material. In the gasifier wall 211, the outer peripheral portion 264 and the protection wall 269 are selectively provided on the internal space 154 side which is a corrosive atmosphere and has high temperature. Thus, the pipe 262 and the board 266 of the gasifier wall 211 can be protected from use environments of corrosion and high temperature. However, if a temperature change occurs in the wall surface of the gasifier wall 111 due to adhesion and falling-off of slag such as coal on the gasifier wall 211, the stress caused by thermal expansion difference may increase by the board 266, and an unintended stress may be unevenly generated to increase the load.

On the other hand, in at least a part of the gasifier wall 111 in the present embodiment, the board 166 is made of a single member. Furthermore, in the case where the board 166 of at least a part of the gasifier wall 111 is made of second material, the board 166 and the outer peripheral portion 164 made of second material are coupled to each other through the welded portion 168, and hence the board 166 can be formed as a member of single material, and the coupling portion can be welded by a member whose main component is metal of the same kind as the second material, which further facilitates the welding work. For example, the part to which the present embodiment is applied may be applied to the combustor 116, and further may be applied to the diffuser 117. In this manner, by forming the board 166 as a member of single material, the thermal elongation difference caused by temperature rise can be eliminated to suppress the generation of stress in the board 166 caused by the thermal expansion difference. Furthermore, usage environments on the external space 156 side and the internal space 154 side of the gasifier wall 111 have different temperatures, and the pipe 162 is made of first material while the outer peripheral portion 164, the board 166, and the welded portion 168 are made of second material, and hence a stress may be generated by thermal expansion difference between the first material and the second material. In the present embodiment, however, the shapes of the gasifier wall 111 on the external space 156 side and the internal space 154 side have the same shape symmetrical about the plane connecting the axial center of the pipe 162 and the center of the board 166 in the thickness direction, and hence the generation of stress that unevenly increases in part caused by the thermal expansion difference can be suppressed. In addition, in the case where the board 166 is made of second material, the coupling portion can be welded with metal whose main components are the same kind of metal material, and hence a force of the welded portion 168 to couple the board 166 and the outer peripheral portion 164 (water-cooled wall pipe 142) to each other can be increased to enhance the strength of the connection part as compared with the case where different kinds of material are welded, which facilitates the welding work. In this manner, the gasifier wall 111 has a structure in which the stress caused by temperature difference in the board 166 itself is less liable to occur and the board 166 is supported by the water-cooled wall pipe 142 and the welded portion 168 having the axisymmetric structure, and hence the increase in thermal stress caused by the generation of uneven stress caused by the thermal expansion difference between the first material and the second material can be suppressed. By suppressing the increase in thermal stress, the durability can be enhanced. Furthermore, the structure is obtained by combining the double water-cooled wall pipe 142, the board 166, and the welded portion 168, and hence the structure and construction can be made simple.

Note that it is preferred that the board 166 and the welded portion 168 be made of the second material, but may be made of third material different from the second material. The third material has properties similar to those of the second material, specifically, is higher in corrosion resistance and higher in heat resistance than the first material. The third material has the same properties as those of the second material, which facilitates the welding. Furthermore, the board 166 and the welded portion 168 may be made of different materials among materials that are candidates of the second material.

Furthermore, the surface of the gasifier wall 111 on the external space 156 side may also be covered with the second material having high corrosion resistance. Consequently, even when fuel gas or oxygen flows into the external space 156 accidentally during the operation, the gasifier wall 111 can be prevented from being corroded. Thus, the corrosion resistance of the gasifier wall 111 can be further increased.

It is preferred that, in the gasifier wall 111, the ratio of the coefficient of thermal conductivity of the second material to the coefficient of thermal conductivity of the first material (coefficient of thermal conductivity of second material/coefficient of thermal conductivity of first material) be 0.45 or more and 0.7 or less. In the gasifier wall 111, by setting the coefficients of thermal conductivity of the first material and the second material to the above-mentioned range, the difference in elongation caused by the occurrence of temperature difference in the outer peripheral portion 164 caused by the difference in thermal resistance caused by heat passing through the water-cooled wall pipe 142 can be further reduced. Consequently, the thermal stress in the gasifier wall 111 can be suppressed. Furthermore, the difference in thermal resistance in the water-cooled wall pipe 142 can be reduced to enhance the cooling performance of the water-cooled wall pipe 142.

Furthermore, it is preferred that, in the gasifier wall 111, the ratio of the coefficient of thermal expansion of the second material to the coefficient of thermal expansion of the first material (coefficient of thermal expansion of second material/coefficient of thermal expansion of first material) be 0.9 or more and 1.1 or less. One of the coefficient of thermal expansion of the first material and the coefficient of thermal expansion of the second material may be larger than the other. In the gasifier wall 111, by setting the coefficients of thermal expansion of the first material and the second material to the above-mentioned range, the difference in elongation caused by the difference in material or difference in temperature when the temperature rises can be further reduced. Consequently, the thermal stress in the gasifier wall 111 can be suppressed.

Furthermore, it is preferred that, in the gasifier wall 111, the first material be carbon steel or alloy carbon steel containing about 1 to 2% of chromium, and the second material be a nickel-base alloy or an alloy containing nickel. As the carbon steel or the alloy carbon steel, for example, it is preferred to use carbon steel of STB510 or 1Cr steel or 2Cr steel such as STBA23. As the nickel-base alloy, for example, it is preferred to use Inconel (registered trademark) 600, Inconel (registered trademark) 622, Inconel (registered trademark) 625, Inconel (registered trademark) 690, HR-160, HASTELLOY X (trademark), Alloy72, and Alloy72M. In the gasifier wall 111, the above-mentioned materials are used for the first material and the second material, and hence the difference in coefficient of thermal expansion between the first material and the second material can be reduced while increasing the corrosion resistance and temperature durability of the second material to be higher than those of the first material. Consequently, the thermal stress in the gasifier wall 111 can be suppressed, and the corrosion resistance and the temperature durability of the gasifier wall 111 can be enhanced.

It is preferred that the thickness of the outer peripheral portion 164 be larger than 0 and equal to or smaller than 5 mm. Setting the thickness of the outer peripheral portion 164 to be other than 0 like a membrane can prevent the pipe 162 from corrosion. By setting the thickness of the outer peripheral portion 164 to be 5 mm or smaller, the thermal resistance against refrigerant passing through the pipe 162 can be reduced to maintain thermal conductive characteristic necessary for the outer peripheral portion 164 and the board 166, and the temperature rise in the outer peripheral portion 164 can be suppressed to improve the durability of the outer peripheral portion 164. Furthermore, the cooling performance of the gasifier wall 111 can be prevented from being lowered.

Furthermore, in the gasifier wall 111, in the construction to provide the outer peripheral portion 164 on the entire circumference of the pipe 162, the outer peripheral portion 164 can be manufactured by spiral overlay welding. In this manner, the amount of heat input to the pipe 162 can be reduced, and solid solution components (for example, chromium) that influence the durability of the material in the outer peripheral portion 164 can be prevented from being diffused and penetrating to the pipe 162 to reduce the corrosion resistance of the outer peripheral portion 164. Specifically, the load that occurs in the manufacture of the water-cooled wall pipe 142 can be reduced to enhance the durability of the gasifier wall 111. Furthermore, in the welding construction of the outer peripheral portion 164, overlay welding by reciprocating operation in the longitudinal direction, which has been conventionally used, may be employed, but spiral overlay welding is more preferred because the amount of input of heat to the pipe 162 can be reduced.

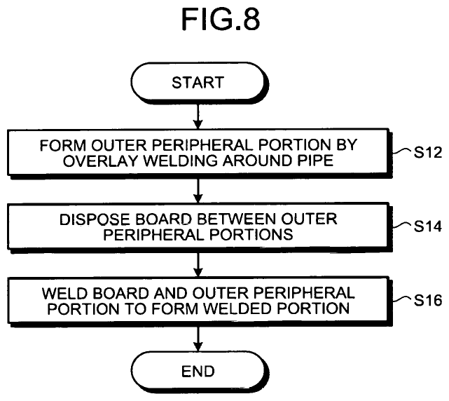

Next, a method of manufacturing a gasifier wall is described with reference to FIG. 8. FIG. 8 is a flowchart illustrating an example of the method of manufacturing a gasifier wall. Processing illustrated in FIG. 8 can be executed by an operator using a processing machine. Furthermore, the processing illustrated in FIG. 8 can be automatically executed by using a processing machine.

The operator performs overlay welding on the entire circumference around the pipe 162 to form the outer peripheral portion 164 (Step S12). Specifically, the second material is overlay-welded to the surrounding of the pipe 162 formed of the first material, thereby forming the outer peripheral portion 164. In the case where the outer peripheral portion 164 is formed on the entire circumference of the pipe 162, the outer peripheral portion 164 is formed by spiral overlay welding where the welding position is moved in the circumferential direction of the pipe 162. The operator repeats the processing of Step S12 to create a plurality of the water-cooled wall pipes 142 in each of which the outer peripheral portion 164 is formed around the pipe 162.

After the plurality of water-cooled wall pipes 142 are created, the operator arranges the water-cooled wall pipes 142 side by side, and disposes board 166 between the outer peripheral portion 164 of a water-cooled wall pipe 142 and the outer peripheral portion 164 of a water-cooled wall pipe 142 (Step S14). The board 166 is in contact with the outer peripheral portions 164 of the water-cooled wall pipes 142. After disposing the outer peripheral portion 164 between a water-cooled wall pipe 142 and a water-cooled wall pipe 142, the operator welds the board 166 and the outer peripheral portion 164 to form the welded portion 168 (Step S16). The operator performs the processing of Step S14 and Step S16 to connect two boards 166 on both peripheral end sides of one water-cooled wall pipe 142 by welding, and finally connect two water-cooled wall pipes 142 to one board 166 serving as the endmost portion among the boards connected by welding, thereby forming the cylindrical gasifier wall 111.

The method of manufacturing a gasifier wall can involve the above-mentioned processing to manufacture the gasifier wall 111. By manufacturing the gasifier wall 111 with the above-mentioned combination, the gasifier wall 111 having high durability and a simple structure can be manufactured. Furthermore, in the case where the outer peripheral portion 164 is formed on the entire circumference of the pipe 162, the outer peripheral portion 164 is formed by spiral overlay welding, and hence the outer peripheral portion 164 can be simply formed with a small amount of heat input.

While the embodiment has been described for the gasifier wall 111 of the gasifier 101 in the integrated coal gasification combined cycle 10, the embodiment may be used for a gasifier wall 111 of a gasifier 101 in a plant other than the integrated coal gasification combined cycle 10, for example, a chemical plant.

Note that a tower gasifier has been described in the present embodiment, but the embodiment can be similarly carried out even when the gasifier is a crossover gasifier.

### REFERENCE SIGNS LIST

10 Integrated coal gasification combined cycle (integrated gasification combined cycle)
11 Coal feeder
11a Coal feed line
14 Gasification unit
15 Char recovery unit
16 Gas purifier
17 Gas turbine unit
18 Steam turbine unit
19 Generator
20 Heat recovery steam generator
41 Compressed air supply line
42 Air separation unit
43 First nitrogen supply line
45 Second nitrogen supply line
46 Char return line
47 Oxygen supply line
49 Gas production line
51 Dust collector
52 Supply hopper
53 Gas discharge line
61 Compressor
62 Combustor
63 Turbine
64 Rotating shaft
65 Compressed air supply line
66 Fuel gas supply line
67 Combustion gas supply line
68 Booster
69 Turbine
70 Flue gas line
71 Steam supply line
72 Steam recovery line
74 Gas purifier
75 Stack
101 Gasifier (internal space)
102 Heat exchanger
110 Pressure vessel
111 Gasifier wall
115 Annulus portion (external space)
116 Combustor
117 Diffuser
118 Reductor
121 Gas discharge outlet
122 Slag bath
126 Burner
127 Burner
131 Evaporator
132 Superheater
134 Economizer
140 Wall portion
142 Water-cooled wall pipe
143 Cooling water circulation mechanism
144 Circulation path
146 Cooling device
148 Pump
150 Inlet header
152 Outlet header
154 Internal space
156 External space
162 Pipe
164 Outer peripheral portion
166 Board (fin)
168 Welded portion

1. A gasifier wall formed of a plurality of pipes through which a cooling medium flows, the plurality of pipes being made of a first material and being arranged side by side, at least a part of the gasifier wall comprising:
an outer peripheral portion stacked on a periphery of each of the pipes and made of a second material having higher corrosion resistance than the pipes;
a board disposed between the outer peripheral portion and an adjacent outer peripheral portion; and
a welded portion coupling the outer peripheral portion and the board, wherein
the outer peripheral portion and the board constitute a wall surface that separates an internal space and an external space from each other, and
the outer peripheral portion covers an entire region of the pipe in a circumferential direction.

2. The gasifier wall according to claim 1, wherein the board is made of a third material having higher corrosion resistance than the pipes.

3. The gasifier wall according to claim 1, wherein gas of 1,500° C. or higher passes through the internal space.

4. The gasifier wall according to claim 1, wherein
the internal space is a corrosive atmosphere, and
the external space is a non-corrosive atmosphere.

5. The gasifier wall according to claim 1, wherein gas having a temperature higher than a temperature of gas in the external space flows in the internal space.

6. The gasifier wall according to claim 1, wherein
a ratio of a coefficient of thermal conductivity of the second material to a coefficient of thermal conductivity of the first material is 0.45 or more and 0.7 or less, and
a ratio of a coefficient of thermal expansion of the second material to a coefficient of thermal expansion of the first material is 0.9 or more and 1.1 or less.

7. The gasifier wall according to claim 1, wherein the outer peripheral portion has a thickness of larger than 0 and 5 mm or smaller.

8. An integrated gasification combined cycle comprising:
a gasification unit having the gasifier wall according to claim 1, the gasification unit being configured to gasify a carbonaceous feedstock to produce combustible gas;
a gas turbine to be rotationally driven by combusting at least a part of the combustible gas produced by the gasification unit;
a steam turbine to be rotationally driven by steam produced by a heat recovery steam generator to which turbine flue gas discharged from the gas turbine is introduced; and
a generator coupled to the gas turbine and the steam turbine.

9. A method of manufacturing a gasifier wall, the method comprising:
forming, on an entire outer circumference of each of a plurality of pipes made of first material, an outer peripheral portion made of a second material having higher corrosion resistance than the first material by overlay welding;
disposing a board between the pipe on which the outer peripheral portion is formed and another pipe on which the outer peripheral portion is formed; and
welding the board and the outer peripheral portion to each other to form a welded portion that fixes the board and the outer peripheral portion to each other.

10. The method of manufacturing a gasifier wall according to claim 9, wherein the forming includes spiral overlay welding in which overlay welding is performed while rotating the pipe to form the outer peripheral portion on the entire outer circumference of the pipe.
